(19) United States
(12) Patent Application Publication
(10) Pub. No.: US 2005/0151718 A1
(43) Pub. Date: Jul. 14, 2005

(54) Coupling module for a network

(75) Inventors: Thomas Vollmer, Aachen (DE); Thomas Durbaum, Langerwehe (DE); Carsten Deppe, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/506,839

(22) PCT Filed: Mar. 3, 2003
(86) PCT No.: PCT/IB03/00833

(30) Foreign Application Priority Data
Mar. 12, 2002 (DE) 102 10 858.7
Mar. 12, 2002 (DE) 102 10 857.9
Apr. 12, 2002 (DE) 102 16 115.1

(51) Int. Cl. G09G 5/00

(52) U.S. Cl. 345/156

(57) ABSTRACT

The invention relates to a coupling module (1) via which communication becomes possible between different electronic appliances of an (in-home) network (30). To this end, the coupling module (1) can be expanded in modular fashion with transmitter and receiver modules (20-27), which in each case create a network interface with the electronic appliances, with the associated transmission protocol in each case. The coupling module (1) may preferably independently detect the connected appliances, and pass on incoming information to the particular addressee in the appropriate protocol.

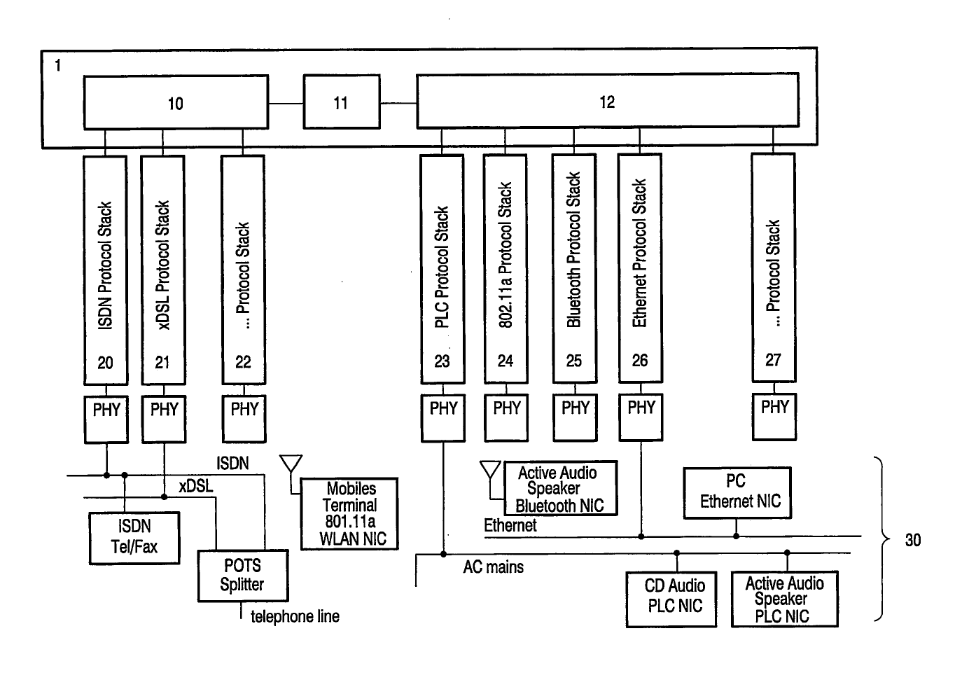

The invention relates to a coupling module for networks interlinking electronic appliances.

Electronic appliances processing data and/or signals are increasingly being used in all areas of life. It is hereby desirable, for the efficient use of these appliances, for them to be coupled together so they can exchange information with each other. To the extent that the in-house area (i.e. the area within buildings, in particular within dwellings and small offices) is affected, the associated networks are designated in-home networks. Televisions, radios, monitors, loudspeakers, cameras, printers, scanners, PCs, telephones, set-top boxes, voice-recognition systems, domestic-appliance control systems, safety devices and similar may be integral to an in-home network of this kind.

The problematic aspect of coupling together different electronic appliances is the fact that a multiplicity of different standards and methods compete for the data transmission between the appliances. In addition to wireless radio-based methods such as Bluetooth, Etsi Bran, DECT, IEEE 1394, IEEE 802.11, we are currently also starting to see so-called Power Line Communications (PLC), i.e. data transmission via the power supply network, as well as (room-wise) transmission with diffuse infrared. There further exist the known transmission routes via Cat 3, 5, 6 cable, telephone lines and coaxial cable (CableTV).

Of these many standards, any given electronic appliance, such as a DVD player, video recorder, loudspeaker or telephone, will generally support only one. In order to incorporate an appliance of this kind into an existing communications network of electronic appliances, a special conversion module must be provided, enabling a conversion to take place between the standard used by the appliance and the standard agreed in the network. In this regard there exist so-called network bridges, which connect together two different network technologies, such as an Ethernet LAN (Local Area Network) and an IEEE 802.11 radio LAN (see U.S. Pat. No. 6,167,120). In the case of a connection of a radio LAN to an Ethernet LAN, this can also be referred to as an “access point” or a “wireless base station”. However, the additional procurement of conversion modules of this kind is costly and necessitates greater involvement for the connection.

Against this background, it is an object of the invention to enable an incorporation of electronic appliances with different communication standards into a network in a manner that is as simple and problem-free as possible for the end user.

This object is achieved by a coupling module with the features as claimed in claim 1. Advantageous embodiments are described in the dependent claims.

The coupling module in accordance with the invention can be incorporated into a network which interlinks electronic appliances for purposes of communication. The coupling module is characterized in that it comprises at least two inputs/outputs for different transmitter and receiver modules or network interfaces, wherein these transmitter and receiver modules (network interfaces) can communicate with the electronic appliances of the network, and wherein the coupling module can transmit data between the transmitter and receiver modules.

The coupling module thereby provides in a network a central communication and conversion unit which can preferably be expanded, and via which different appliances with different communication standards can communicate. In order to allow for a specific or a new standard in the network, all that is needed is for an appropriate transmitter and receiver module to be provided and connected to an input/output of the coupling module. Subsequently, the associated electronic appliance can exchange data with the coupling module via this transmitter and receiver module, wherein the coupling module then exchanges the data in the correct protocol with the respective communication partner via another transmitter and receiver module. By virtue of the coupling module, a so-called “plug and play” that is simple for the end consumer to perform thereby becomes possible for all interlinkable appliances. Owing to its modular structure, virtually any matching and expansion of the system can take place in line with the particular circumstances, wherein the connection of new transmitter and receiver modules will also enable the subsequent integration of future technologies. With in-home networks, it is also possible to access the Internet and telecommunications services at virtually any location within the building by the interfacing of access networks located outside the building.

The coupling module is preferably set up in such a way that it can convert between different transmission protocols of the connected transmitter and receiver modules. In this manner, at least part of the necessary conversion in the communication path between two electronic appliances can be taken over by the coupling module, as a result of which the transmitter and receiver modules may be designed accordingly more simply, and may, for example, be reduced essentially to the function of a physical interface.

In accordance with a development of the invention, the coupling module may be set up to determine independently the transmission protocol used by an electronic appliance of the network, and subsequently to use this protocol and the appropriate transmitter and receiver module for communication with this appliance. This automatic determination of the associated protocol further simplifies the use of the coupling module for the end consumer, since he does not have to bother with installing and setting the various technical standards.

The coupling module can undertake the conversion of all data channels and incoming data for a preferred electronic appliance, for a permanently set one, or for all those used.

Preferably, however, it is set up to determine from the incoming data the electronic appliance addressed by this data, and then to pass the data on specifically to the addressed appliance, via the appropriate transmitter and receiver module, in the associated transmission protocol. In this manner, the coupling module can create flexible connections between different appliances. It is not necessary for specific transmission paths to be permanently set between the appliances, since the particular receiver of an item of information is apparent from the address.

The coupling module is advantageously formed by a programmable data-processing unit with a data/program memory connected to it. The function of the coupling module can then essentially be defined by appropriate programming of the data-processing unit, which enables a very high degree of flexibility as regards new or future communication protocols. In order to make full use of this flexibility with an installed coupling module, the data/program memory is preferably accessible from outside, so updated data and programs can be deposited as needed.

For more extensive communication, in particular with external sources, it is preferable if the coupling module undertakes the function of a firewall and/or a proxy server in the transmission path between different transmitter and receiver modules. A firewall is a security system that protects an Intranet from access by unauthorized users, and prevents the unauthorized communication of internal computers with appliances external to the network (and vice versa). Proxy servers are computers that store frequently used data, such as Internet pages, temporarily, in order to enable rapid access and prevent long transmission paths. The transmitter and receiver modules that can be connected to the coupling module may be set up for different standards of wireless or on-wire communication. In particular, they may be set up for communication in accordance with, for example, the standards Docsis, Eurodocsis, CableTV, GSM, UMTS, GPRS, ISDN, XDSL, Power Line Communications (PLC), IEEE 802.11 (a, b, . . . ), ETSI Bran, Hiperlan 1/2, DECT, HomeRF, Bluetooth, USB, IEEE 1394, IrDa, and/or Ethernet.

In accordance with a development of the coupling module, it may, additionally, be set up to pass incoming data on after signal amplification in the same transmission protocol. This means that the coupling module also takes on the function of a signal-amplification repeater. In the case of transmission with power line communications, a re-transmission of data on a phasing line other than the input line may preferably take place.

The coupling module may further be set up to take on standby functions of connected electronic appliances. As a result, it is possible to switch the electronic appliances themselves off completely, and to operate only the coupling module as a central standby module.

The invention will be further described with reference to an example of an embodiment shown in the drawing, to which, however, the invention is not restricted.

The FIGURE shows schematically the components of a coupling module in accordance with the invention, with connected transmitter and receiver modules and electronic appliances.

The Figure shows a so-called in-home network 30 with various electronic appliances, such as an ISDN telephone and fax, a POTS (Plain Old Telephone System) splitter, a mobile terminal with 802.11a WLAN (Wireless Local Area Network) NIC (Network Interface Card), an active audio loudspeaker with Bluetooth NIC, a PC with Ethernet NIC, an Ethernet (IEEE 802.3) LAN and a power supply network (Power line AC) to which a CD player with PLC NIC and an active loudspeaker with PLC NIC are connected. The entire network 30 thereby comprises multiple sub-networks, to which different appliances with different wireless or on-wire communication protocols are connected.

In order to enable communication between the different networks and electronic appliances in a simple, cost-effective manner, a conversion unit comprising a coupling module 1 with various transmitter and receiver modules 20-27 is proposed in accordance with the invention. The coupling module 1 in accordance with the invention comprises a data-processing unit (microprocessor) with connected electronic memory, wherein a so-called multi-protocol access-network router/residential gateway 10 and a multi-protocol in-home network bridge/router/gateway 12 are formed by appropriate programming. When a communication is present on layer 2 of the ISO/OSI reference network-protocol model, it is designated a “bridge”; with a communication on level 3, it is designated a “router”, and with a communication on higher layers, a “gateway”. If a connection to an external access network exists (for access to the Internet, for example), reference is also made to a “residential gateway”.

Between the two multi-protocol converters 10 and 12 is arranged a firewall and/or proxy server 11 in order to separate internal components of the network from external components, and to enable more rapid access to external data.

The transmitter and receiver modules 20-27 are in each case formed by a physical interface PHY, which enables physical communication with appliances connected either wirelessly or on-wire, and an associated communication protocol. The transmitter and receiver modules 20-27 may be exchanged or retrofitted in modular fashion, so that coupling module 1 can be flexibly and continuously matched to newly added sub-networks in the in-home network 30.

By means of coupling module 1 described above, Service Discovery protocols for IP (Internet Protocol)-based in-home networks, such as “Universal Plug and Play (UpnP)” (from Microsoft), can extend their search for network services present in the building to include sub-networks that are based on non-IP-based transmission and network technologies, such as DECT.

List of Reference Numbers

1 Coupling module
10 Multi-protocol access-network router/residential gateway
11 Firewall/proxy server
12 Multi-protocol in-home network bridge/router/gateway
20-27 Transmitter and receiver modules
30 Network

1. A coupling module (1) for a network (30) interlinking electronic appliances, characterized in that it comprises at least two inputs/outputs for connecting different transmitter and receiver modules (20-27), wherein these transmitter and receiver modules can communicate with the electronic appliances of the network, and wherein the coupling module (1) can transmit data between the transmitter and receiver modules (20-27).

2. A coupling module as claimed in claim 1, characterized in that it is set up in such a way that it can convert between different transmission protocols of the connected transmitter and receiver modules (20-27).

3. A coupling module as claimed in claim 2, characterized in that it is set up to determine the transmission protocol used by an electronic appliance of the network (30), and to use this protocol and the appropriate transmitter and receiver module (20-27) for communication with this appliance.

4. A coupling module as claimed in claim 1, characterized in that it is set up to determine from the incoming data the electronic appliance addressed by this data, and then to pass the data on to the addressed appliance, via the appropriate transmitter and receiver module (20-27), in the associated transmission protocol.

5. A coupling module as claimed in claim 1, characterized in that it is formed by a programmable data-processing unit with a data/program memory connected to it.

6. A coupling module as claimed in claim 1, characterized in that it is set up to undertake the function of a firewall (11) in the transmission path between different transmitter and receiver modules (20-27).

7. A coupling module as claimed in claim 1, characterized in that it is set up to undertake the function of a proxy server (11) in the transmission path between different transmitter and receiver modules (20-27).

8. A coupling module as claimed in claim 1, characterized in that the transmitter and receiver modules (20-27) enable communication in accordance with, for example, the standards Docsis, Eurodocsis, CableTV, GSM, UMTS, GPRS, ISDN, XDSL, Power Line Communications (PLC), IEEE 802.11, ETSI Bran, Hiperlan 1/2, DECT, HomeRF, Bluetooth, USB, IEEE 1394, IrDa, and/or Ethernet.

9. A coupling module as claimed in claim 1, characterized in that it is set up to pass incoming data on after signal amplification in the same transmission protocol.

10. A coupling module as claimed in claim 1, characterized in that it is set up to take on standby functions of connected electronic appliances.
